(19) United States
(12) Patent Application Publication
(10) Pub. No.: US 2009/0165215 A1
(43) Pub. Date: Jul. 2, 2009

(54) PROCESS FOR THE ENHANCEMENT OF THERMOSTABILITY

(75) Inventors: Edvard Ham, Riehen (CH); Claudius Brinkmann, Lörrach (DE); Byron Scott Bailey, Mount Airy, NC (US); Axel Pierach, Rheinfelden (CH); Pius Paracchini, Therwil (CH)

Correspondence Address: HUNTSMAN INTERNATIONAL LLC, LEGAL DEPARTMENT, 10003 WOODLOCH FOREST DRIVE, THE WOODLANDS, TX, 77380, US

(73) Assignee: HUNTSMAN INTERNATIONAL LLC, THE WOODLANDS (TX)

(21) Appl. No.: 12/298,086

(22) PCT Filed: Apr. 17, 2007
(86) PCT No.: PCT/EP07/53731

§ 371 Date: Oct. 22, 2008

(30) Foreign Application Priority Data
Apr. 24, 2006 (EP) 06112948.2

(51) Int. Cl. D06M 13/425; C09K 3/00; D06M 13/335; D06M 13/248; D06M 13/262

(52) U.S. Cl. 8/115.51; 252/182.12; 252/182.3

(57) ABSTRACT

The invention relates to an auxiliary composition comprising
(A) from 5 to 95% by weight, based on the total composition, of at least one compound of formula (1a) or (1b)

Y₁—X—Y₂ (1a)

A₁A₂N—OH (1b)
wherein X is a divalent aliphatic, aromatic, araliphatic or cycloaliphatic radical,
Y₁ and Y₂ are each independently of the other —OH, —CO—OR₁, —NR₁R₂, —CO—NH—NR₁R₂ or —NH—CO—NH—NR₁R₂, wherein R₁ and R₂ are each independently of the other hydrogen, C₁-C₂₀alkyl, C₁-C₂₀alkoxy, C₅-C₂₄cycloalkyl, C₅-C₃₀aryl or
C₆-C₃₆aralkyl, it being possible for the alkyl, alkoxy, cycloalkyl, aryl or aralkyl groups to be unsubstituted or substituted by one or more hydroxy, amino, sulfo or carboxyl groups or halogen atoms,
A₁ and A₂ are each independently of the other C₁-C₂₀alkyl or C₆-C₃₆aralkyl;
(B) from 0 to 95% by weight, based on the total composition, of one or more anionic or non-ionic surfactants or dispersants; and
(C) from 0 to 85% by weight, based on the total composition, of a solid, inorganic or organic acid;
the sum of the amounts of components A+B+C being 100% by weight in each case, and also to a method of improving the thermal stability of natural or synthetic textile fibre materials that are undyed, fluorescent whitened or dyed.

The present invention relates to an auxiliary composition and also to a method of improving the thermal stability of natural or synthetic textile fibre materials that are undyed, fluorescent whitened or dyed.

In various textile-processing procedures (pretreatment, application of fluorescent whitening agents, dyeing, finishing), the textile fibre materials are exposed to a heat treatment. Particularly in the case of goods that are undyed and that may have been fluorescent whitened, this frequently results in undesirable yellowing.

The action of heat also often results in undesirable effects before and after dyeing.

For example, a thermal pretreatment may lead to oxidative damage to polyamide, which manifests itself, for example, in increased yellowing or loss of tensile strength, or which may also have a negative effect on dyeability.

Thermal treatment after the dyeing process may likewise result in unacceptable alterations in shade.

It has now been found that the above-mentioned disadvantageous effects can be substantially reduced by the use of a specific textile auxiliary.

The present invention relates to a composition comprising
(A) from 5 to 95% by weight, based on the total composition, of at least one compound of formula (1a) or (1b)

Y₁—X—Y₂ (1a)

A₁A₂N—OH (1b)
wherein X is a divalent aliphatic, aromatic, araliphatic or cycloaliphatic radical,
Y₁ and Y₂ are each independently of the other —OH, —CO—OR₁, —NR₁R₂, —CO—NH—NR₁R₂ or —NH—CO—NH—NR₁R₂, wherein R₁ and R₂ are each independently of the other hydrogen, C₁-C₂₀alkyl, C₁-C₂₀alkoxy, C₅-C₂₄cycloalkyl, C₅-C₃₀aryl or
C₆-C₃₆aralkyl, it being possible for the alkyl, alkoxy, cycloalkyl, aryl or aralkyl groups to be unsubstituted or substituted by one or more hydroxy, amino, sulfo or carboxyl groups or halogen atoms,
A₁ and A₂ are each independently of the other C₁-C₂₀alkyl or C₆-C₃₆aralkyl;
(B) from 0 to 95% by weight, based on the total composition, of one or more anionic or non-ionic surfactants or dispersants; and
(C) from 0 to 85% by weight, based on the total composition, of a solid, inorganic or organic acid;
the sum of the amounts of components A+B+C being 100% by weight in each case.

Aliphatic radicals X in formula (1a) are, for example, ethylene, propylene, trimethylene, propane-1,1-diyl, tetramethylene, hexamethylene, octamethylene and decamethylene or linear or branched alkylene that is interrupted by one or more O atoms or —NH—, —N-alkyl- or —N-alkylene-NH₂— groups.

Suitable cycloaliphatic radicals X are, for example, cyclohexane-1,2-diyl, cyclohexane-1,3-diyl, cyclohexane-1,4-diyl and also

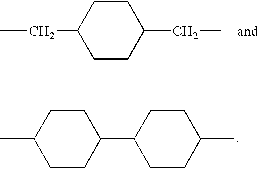

Examples of aromatic radicals X are 1,2-phenylene, 1,3-phenylene, 1,4-phenylene, biphenylene, 1,2-naphthalenediyl, 1,3-naphthalenediyl, 1,4-naphthalenediyl, 1,5-naphthalenediyl, 1,6-naphthalenediyl, 1,8-naphthalenediyl, 2,3-naphthalenediyl, 2,6-naphthalenediyl, 2,7-naphthalenediyl and also

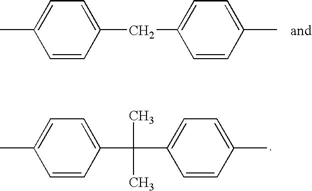

Divalent araliphatic radicals are, for example,

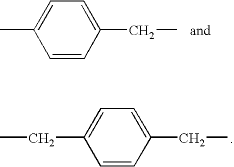

C₁-C₂₀Alkyl as a radical R₁, R₂, A₁ or A₂ can be, for example, methyl, ethyl, n-propyl, isopropyl, n-butyl, isobutyl, sec-butyl, tert-butyl, n-pentyl, neopentyl, n-hexyl, n-octyl or n-dodecyl.

Examples of C₁-C₂₀alkoxy groups as R₁ or R₂ are methoxy, ethoxy, n-propoxy, isopropoxy, n-butoxy, isobutoxy, sec-butoxy, tert-butoxy, n-pentyloxy, neopentyloxy, n-hexyloxy, n-octyloxy and n-dodecyloxy.

Suitable C₅-C₂₄cycloalkyl groups are, for example, cyclopentyl, cyclohexyl and decalinyl.

C₅-C₃₀Aryl groups as a radical R₁ or R₂ are, for example, phenyl, tolyl, mesityl, isityl, naphthyl or anthryl.

Suitable C₆-C₃₆aralkyl groups are, for example, benzyl and 2-phenylethyl.

Preference is given to the use of compounds of formula (1a) wherein X is ethylene, propylene, trimethylene, tetramethylene, pentamethylene, hexamethylene, octamethylene, phenylene or methylene-p-diphenylene.

Preference is further given to compounds of formula (1a) wherein Y₁ and Y₂ are —NR₁R₂, —CO—NH—NR₁R₂ or —NH—CO—NH—NR₁R₂, wherein R₁ and R₂ are hydrogen, C₁-C₁₂alkyl or C₅-C₂₄aryl.

Special preference is given to compounds of formula (1a) wherein Y₁ and Y₂ are —NR₁R₂, —CO—NH—NR₁R₂ or —NH—CO—NH—NR₁R₂, wherein R₁ and R₂ are hydrogen, methyl or phenyl.

Examples of suitable compounds of general formula (1a) are the compounds of formulae (101)-(105)

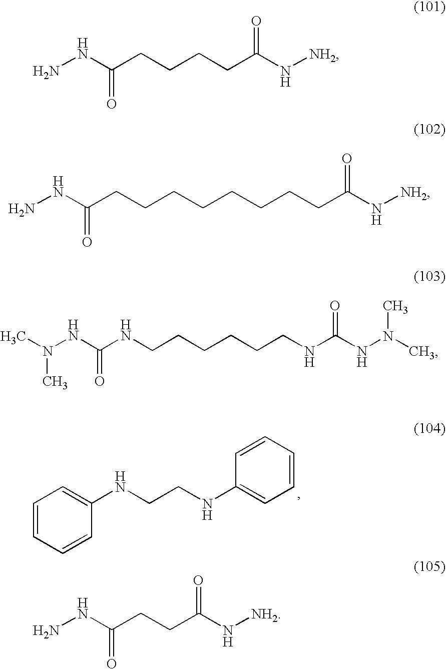

The compounds of formula (1a) are known and can be synthesised by known methods.

Suitable compounds of formula (1b) are N,N-dimethylhydroxylamine, N,N-diethylhydroxylamine, N,N-di-n-butylhydroxylamine, N,N-dibenzyl hydroxylamine and N-benzyl-N-methylhydroxylamine.

In principle any anionic or non-ionic surfactant or dispersant can be used as component B in the compositions according to the invention.

Examples of suitable anionic surfactants are alkylsulfonates, alkylbenzenesulfonates, alkylnaphthalenesulfonates, alkylsulfates, alkyl ether sulfates, ethoxylated or propoxylated arylsulfates, ethoxylated or propoxylated arylphosphates, ethoxylated or propoxylated aralkylsulfates and ethoxylated or propoxylated aralkylphosphates.

Suitable non-ionic surfactants are, for example, fatty alcohol polyglycol ethers, alkylphenol polyglycol ethers, sorbitan fatty acid esters, fatty acid polyglycol esters, ethylene oxide/propylene oxide block polymers and polyglycerol fatty acid esters.

In the compositions according to the invention preference is given to the use, as component B, of a compound of formula (2)

R-Z-SO₃M (2)

wherein Z is a divalent aromatic radical,
R is C₁-C₂₀alkyl, C₁-C₂₀alkoxy, C₅-C₂₄cycloalkyl, C₅-C₃₀aryl, C₆-C₃₆aralkyl, —NHR₃, —NR₄R₅, —NHCOR₆ or —NR₇COR₈, wherein R₃, R₄, R₅, R₆, R₇ and R₈ are each independently of the others C₁-C₂₀alkyl, C₁-C₂₀alkoxy, C₅-C₂₄cycloalkyl, C₅-C₃₀aryl or C₆-C₃₆aralkyl,
it being possible for the alkyl, alkoxy, cycloalkyl, aryl or aralkyl groups to be unsubstituted or substituted by one or more hydroxy, amino, sulfo or carboxyl groups or halogen atoms, and
M is hydrogen, an alkali metal cation or an unsubstituted ammonium ion or an ammonium ion substituted by one or more C₁-C₂₀alkyl groups.

In formula (2), Z is preferably phenylene or naphthylene and R is preferably C₁-C₂₀alkyl.

Especially preferred components B are the compounds of formulae (2a), (2b), (2c) and (2d)

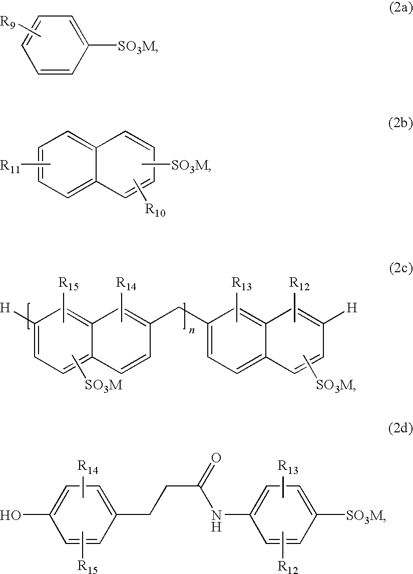

wherein R₉ is C₁-C₂₀alkyl, R₁₀, R₁₁, R₁₂, R₁₃, R₁₄ and R₁₅ are each independently of the others hydrogen or C₁-C₂₀alkyl, n is a number from 1 to 10 and M is as defined hereinbefore.

Suitable compounds of formula (2a) are, for example, sodium octylbenzenesulfonate, sodium nonylbenzenesulfonate and sodium dodecylbenzenesulfonate.

In the compositions according to the invention preference is given to the use, as component B, of an alkylbenzenesulfonate or an alkylsulfate.

In the context of this invention, solid, inorganic or organic acids suitable as component C of the compositions according to the invention are understood to be compounds having a melting point F. >40° C.

Both polybasic inorganic acids and their acid salts, for example H₃PO₄, NaH₂PO₄, H₄P₂O₇, Na₂H₂P₂O₇ and Na₂H₄P₃O₁₀, and unsubstituted or substituted organic mono-, di- or tri-carboxylic acids or -sulfonic acids are suitable for the purpose.

Examples of suitable solid organic acids are monocarboxylic acids, for example benzoic acid, salicylic acid, ascorbic acid and toluic acid, dicarboxylic acids, for example oxalic acid, malonic acid, succinic acid, glutaric acid, adipic acid, pimelic acid, suberic acid, azelaic acid, sebacic acid, maleic acid, fumaric acid, mandelic acid, malic acid, tartaric acid, citric acid and racemic acid, and tricarboxylic acids, for example trimellitic acid.

Further organic acids that are suitable as component C in the context of this invention are carboxyl-group-containing oligomers or polymers having a molecular weight (weight average) M_{w}>200, for example homo- or co-polymers of unsaturated carboxylic acids, such as acrylic acid, methacrylic acid or crotonic acid.

An α-hydroxycarboxylic acid is preferably used as component C.

Special preference is given to tartaric acid, oxalic acid, adipic acid and citric acid.

The amounts of components A, B and C in the compositions according to the invention can vary within wide ranges.

Preference is given to compositions comprising, based on the total composition, from 10 to 50% by weight, especially from 20 to 40% by weight, of component A, from 44 to 85% by weight, especially from 55 to 75% by weight, of component B and from 0 to 75% by weight, especially from 10 to 60% by weight, of component C.

The invention relates also to a method of improving the thermal stability of natural or synthetic textile fibre materials that are undyed, fluorescent whitened or dyed with reactive, acid, metal complex or disperse dyes, wherein the fibre material is treated with a liquor comprising a composition comprising the above-mentioned components A, B and C.

The textile fibre materials which can be treated using the method according to the invention may be natural or synthetic fibres and also mixtures thereof. Examples of natural fibres are plant fibres, for example cotton, viscose, flax, rayon or linen, and animal fibres, for example wool, mohair wool, cashmere wool, angora wool and silk. Synthetic fibres are, for example, polyester, polyamide, polyurethane and polyacrylonitrile fibres.

The method according to the invention is suitable for the treatment of, especially, polyamide fibre materials.

As polyamide fibre material there comes into consideration natural polyamide fibre material, for example wool or silk, or synthetic polyamide fibre material, for example polyamide 6 or polyamide 6.6, or fibre blends, for example wool/cellulose, polyamide/cellulose, polyamide/wool, polyamide/polyester or, especially, polyamide/elastane blends. The fibre material is preferably synthetic polyamide fibre material.

The textile material can be used in any form, for example in the form of fibre, yarn, woven fabric or knitted fabric.

The auxiliary compositions used in the method according to the invention, comprising the above-defined components A, B and C, are present in the liquor advantageously in an amount of from 0.1 g/l to 100 g/l, preferably from 0.5 g/l to 50 g/l and especially from 1.0 g/l to 40 g/l.

The composition according to the invention can be applied to the textile fibre material by customary dyeing or printing methods, for example by spray application or foam application, by the exhaust process or, preferably, the pad-dyeing process.

Special apparatus is not necessary. It is possible to use, for example, the customary dyeing apparatus, e.g. open baths, winch becks, jiggers or paddle, jet or circulatory apparatus.

In addition to comprising water and the textile auxiliary according to the invention, the liquors may comprise further additives, for example wetting agents, anti-foams, levelling agents, fluorescent whitening agents or agents that influence the properties of the textile material, for example softeners, flame-proofing agents or dirt-, water- and oil-repellents and also water-softeners and natural or synthetic thickeners, e.g. alginates and cellulose ethers.

As mentioned above, the method according to the invention can advantageously be used for the thermal stabilisation both of undyed textile fibre material (white goods), which may have been treated with a fluorescent whitening agent, and of dyed textile fibre material.

In the case of undyed or fluorescent whitened textile fibre material, the yellowing caused by heat treatment during heat-setting (hot air) or during moulding processes (contact heat) is prevented or reduced.

The method according to the invention is especially effective in the treatment of fluorescent whitened textile fibre material.

In the thermal stabilisation of dyed textile fibre material, the composition according to the invention can be applied before, during or after dyeing.

When the composition is used before dyeing, yellowing of the undyed goods during so-called pre-setting can be prevented or reduced.

The composition according to the invention is preferably applied after dyeing of the textile fibre material with reactive, acid, metal complex or disperse dyes.

The after-treatment of the dyed textile fibre material with the textile auxiliary according to the invention brings about especially a certain degree of fibre protection during post-setting (heat setting) and effectively reduces the alteration in shade that frequently occurs in that process step, that is to say the shade remains constant, there is no dulling and no loss of colour strength.

In the case of undyed or fluorescent whitened textile fibre materials, no appreciable reduction in whiteness is observed after the treatment with the composition according to the invention.

It has also been found that, surprisingly, the treatment of the textile fibre material with the composition according to the invention also brings about an improvement in fastness to ozone, NOₓ and chlorine.

The invention accordingly relates also to a method of improving the fastness to ozone, NOₓ and chlorine of natural or synthetic textile fibre materials that are undyed, fluorescent whitened or dyed with reactive, acid, metal complex or disperse dyes, wherein the fibre material is treated with a liquor comprising a composition comprising the above-mentioned components A, B and C.

So-called storage yellowing, that is to say the yellowing that occurs during storage of the textile materials, can surprisingly also be effectively reduced by treatment with the composition according to the invention Resistance to storage yellowing is generally measured using the Courtauld yellowing test.

The Courtauld test, developed by the Courtauld company and further developed by Marks & Spencer, is an established test in the textile industry for assessing the sensitivity to yellowing caused by phenolic antioxidants.

The textile fibre materials treated with the composition according to the invention have a high Courtauld's fastness.

The compositions according to the invention may comprise as further additives, for example, wetting agents, dispersants or pH regulators.

The following Examples serve to illustrate the invention. Unless otherwise indicated, temperatures are given in degrees Celsius, parts are parts by weight and percentages relate to percent by weight. Parts by weight relate to parts by volume in the same ratio as kilograms to litres.

### EXAMPLES 1-13

### Treatment of Fluorescent Whitened Polyamide

### (a) Whitening Process

A PA 6.6 textured tricot is treated by the exhaust process with an aqueous liquor containing 2.0% Uvitex® NFW liquid (fluorescent whitener, Ciba Specialty Chemicals) and 1.0 μl of Ultravon® EL (dispersant, Ciba Specialty Chemicals). The pH is adjusted to 4.5 with acetic acid.

Liquor ratio 1:20, 30 min/95° C.

### (b) Application of the Auxiliary

The whitened fabric is treated by the pad-dyeing process with an aqueous liquor comprising the auxiliary compositions given in Table 1.

Liquor pick-up 100%; drying at 70° C.
Whiteness according to Ganz: 230

The fabric is then subjected to a heat setting test (60 s/210° C.) and a moulding test (60 s/210° C.); the results compared to untreated material are set out in Table 2:

TABLE 1
Auxiliary compositions

| Example | 1 | 2 | 3 | 4 | 5 | 6 |
|---|---|---|---|---|---|---|
| Adipic acid | 30% | 30% | 90% | 30% | 30% | 30% |
| dihydrazide | | | | | | |
| Sodium dodecyl- | 55% | 65% | | 10% | 61.25% | 35% |
| benzenesulfonate | | | | | | |
| Sodium dodecyl- | | | | | | |
| sulfate | | | | | | |
| Tartaric acid | 15% | 5% | | 60% | | |
| Adipic acid | | | 10% | | | 35% |
| Citric acid | | | | | 8.75% | |
| Oxalic acid | | | | | | |
| Na₂H₃P₃O₁₀ | | | | | | |

| Example | 7 | 8 | 9 | 10 | 11 | 12 | 13 |
|---|---|---|---|---|---|---|---|
| Adipic acid | 30% | 30% | 30% | 30% | 20% | 30% | 30% |
| dihydrazide | | | | | | | |
| Sodium dodecyl- | 52.5% | 17.5% | | 70% | 47% | 50% | |
| benzenesulfonate | | | | | | | |
| Sodium dodecyl- | | | 70% | | | | |
| sulfate | | | | | | | |
| Tartaric acid | | | | | | 20% | |
| Adipic acid | | 52.5% | | | | | |
| Citric acid | 17.5% | | | | | | |
| Oxalic acid | | | | | 33% | | |
| Na₂H₃P₃O₁₀ | | | | | | | 70% |

TABLE 2
Whiteness and Courtauld's fastness

| Auxiliary composition | | Whiteness (Ganz) | | |
|---|---|---|---|---|
| according | Amount | after heat setting | after moulding | Courtauld's |
| to Example | [g/l] | 60 s/210° C. | 60 s/210° C. | fastness |
| untreated | — | 68 | 141 | 2-3 |
| 7 | 10 | 187 | 179 | 4 |
| 8 | 10 | 212 | 221 | 5 |
| 6 | 10 | 213 | 227 | 5 |
| 5 | 10 | 215 | 217 | 5 |
| 9 | 10 | 223 | 220 | |
| 10 | 10 | 229 | 227 | 3-4 |
| untreated | — | 74 | 185 | 3 |
| 2 | 10 | 247 | 245 | 4 |
| 4 | 10 | 248 | 246 | 4-5 |
| 11 | 15 | 246 | 251 | 4-5 |
| 12 | 10 | 236 | 234 | |
| ¹⁾ untreated | — | 155 | −23 | |
| 13 | 30 | 178 | 149 | |

¹⁾ heat setting 60 s/180° C.; moulding 45 s/200° C.

### EXAMPLES 14-16

### Treatment of Dyed Polyamide/Elastane

A PA 6.6/elastane fabric (82:18) is dyed by the exhaust process with an aqueous liquor containing 1.7% Lanaset® Blue 2R (Ciba Specialty Chemicals) and 1.0% Lanaset® Violet B (Ciba Specialty Chemicals) at pH 4.5.

The fabric pre-dyed in that manner is treated by the pad-dyeing process with an aqueous liquor in each case containing 30 g/l of an auxiliary composition consisting of 30% adipic acid dihydrazide and 70% Irgasol® DAM (dispersant, Ciba Specialty Chemicals) (Example 14), or 30% adipic acid dihydrazide and 70% Tamol® NN 904 (dispersant) (Example 15), or 30% adipic acid dihydrazide and 70% sodium dodecylbenzenesulfonate (Example 16) (liquor pick-up about 70%), for 2 minutes at 70° C. and is then heat-set (60 s/180° C.). The dyed fabric is then subjected to a chlorine bath water test (100 ppm Cl₂).

Table 3 shows the deviations in shade (DEF values) in comparison with the reference (untreated dyed fabric).

TABLE 3

| | Colour | | |
|---|---|---|---|
| | strength | DEF | Rating |
| Reference dyeing before chlorine bath water | 100% | 0 | 5 |
| test | | | |
| Reference dyeing after chlorine bath water | 36% | 14.41 | 1 |
| test | | | |
| Example 14 | 100% | 1.73 | 4 |
| Example 15 | 98% | 1.59 | 4 |
| Example 16 | 69% | 5.27 | 2-3 |

1. A composition comprising
(A) from 5 to 95% by weight, based on the total composition, of at least one compound of formula (1a) or (1b)
Y₁—X—Y₂ (1a)
A₁A₂N—OH (1b),
wherein X is a divalent aliphatic, aromatic, araliphatic or cycloaliphatic radical,
Y₁ and Y₂ are each independently of the other —OH, —CO—OR₁, —NR₁R₂, —CO—NH—NR₁R₂ or —NH—CO—NH—NR₁R₂, wherein R₁ and R₂ are each independently of the other hydrogen, C₁-C₂₀ alkyl, C₁-C₂₀ alkoxy, C₅-C₂₄ cycloalkyl, C₅-C₃₀ aryl or
C₆-C₃₆ aralkyl, it being possible for the alkyl, alkoxy, cycloalkyl, aryl or aralkyl groups to be unsubstituted or substituted by one or more hydroxy, amino, sulfo or carboxyl groups or halogen atoms,
A₁ and A₂ are each independently of the other C₁-C₂₀ alkyl or C₆-C₃₆ aralkyl;
(B) from 0 to 95% by weight, based on the total composition, of one or more anionic or non-ionic surfactants or dispersants; and
(C) from 0 to 85% by weight, based on the total composition, of a solid, inorganic or organic acid;
the sum of the amounts of components A+B+C being 100% by weight in each case.

2. A composition according to claim 1, comprising as component (A) a compound of formula (1a) wherein X is ethylene, propylene, trimethylene, tetramethylene, pentamethylene, hexamethylene, octamethylene, phenylene or methylene-p-diphenylene.

3. A composition according to claim 1, comprising as component (A) a compound of formula (1a) wherein Y₁ and Y₂ are —NR₁R₂, —CO—NH—NR₁R₂ or —NH—CO—NH—NR₁R₂, wherein R₁ and R₂ are hydrogen, C₁-C₁₂ alkyl or C₅-C₂₄ aryl.

4. A composition according to claim 1, comprising as component (A) a compound of formula (1a) wherein Y₁ and Y₂ are —NR₁R₂, —CO—NH—NR₁R₂ or —NH—CO—NH—NR₁R₂, wherein R₁ and R₂ are hydrogen, methyl or phenyl.

5. A composition according to claim 1, comprising as component (A) a compound of formula (101)-(105)

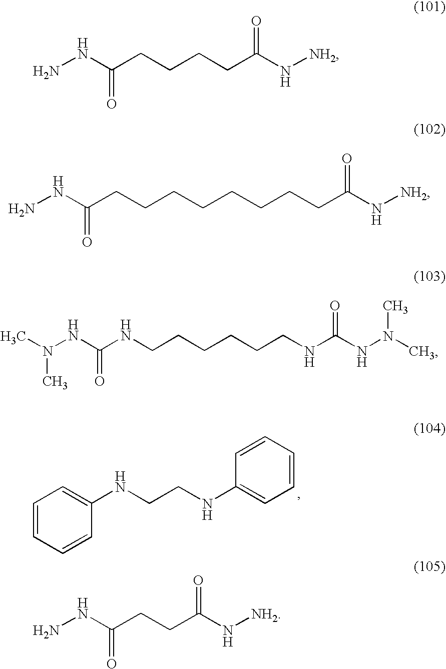

6. A composition according to claim 1, comprising as component (A) a compound of formula (1b) wherein A₁ and A₂ are ethyl.

7. A composition according to claim 1, comprising as component (B) a compound of formula (2)
R-Z-SO₃M (2)
wherein Z is a divalent aromatic radical,
R is C₁-C₂₀ alkyl, C₁-C₂₀ alkoxy, C₅-C₂₄ cycloalkyl, C₅-C₃₀ aryl, C₆-C₃₆ aralkyl, —NHR₃, —NR₄R₅, —NHCOR₆ or —NR₇COR₈, wherein R₃, R₄, R₅, R₆, R₇ and R₈ are each independently of the others C₁-C₂₀ alkyl, C₁-C₂₀ alkoxy, C₅-C₂₄ cycloalkyl, C₅-C₃₀ aryl or C₆-C₃₆ aralkyl,
it being possible for the alkyl, alkoxy, cycloalkyl, aryl or aralkyl groups to be unsubstituted or substituted by one or more hydroxy, amino, sulfo or carboxyl groups or halogen atoms, and
M is hydrogen, an alkali metal cation, or an unsubstituted ammonium ion or an ammonium ion substituted by one or more C₁-C₂₀ alkyl groups.

8. A composition according to claim 7, comprising as component (B) a compound of formula (2) wherein Z is phenylene or naphthylene and R is C₁-C₂₀alkyl.

9. A composition according to claim 7, comprising as component (B) a compound of formula (2a), (2b), (2c) or (2d) 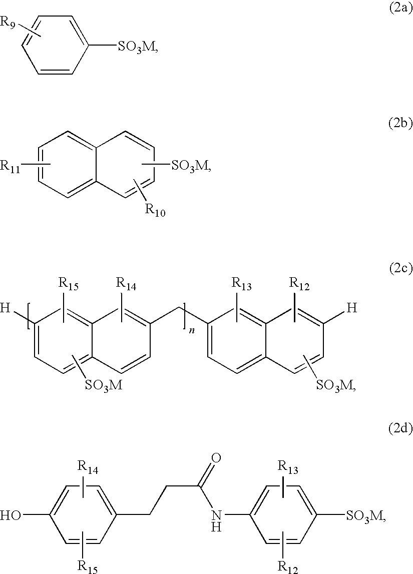
wherein R₉ is C₁-C₂₀ alkyl,
R₁₀, R₁₁, R₁₂, R₁₃, R₁₄ and R₁₅ are each independently of the others hydrogen or C₁-C₂₀ alkyl,
n is a number from 1 to 10 and
M is as defined in claim 8.

10. A composition according to claim 7, comprising as component (B) an alkylbenzenesulfonate or an alkylsulfate.

11. A composition according to claim 1, comprising as component (C) an α-hydroxycarboxylic acid.

12. A composition according to claim 1, comprising as component (C) tartaric acid, oxalic acid, adipic acid or citric acid.

13. A method of improving the thermal stability of natural or synthetic textile fibre materials that are undyed, fluorescent whitened or dyed with reactive, acid, metal complex or disperse dyes, wherein the fibre material is treated with a liquor comprising a composition according to claim 1.

14. A method of improving the fastness to ozone, NOₓ and chlorine of natural or synthetic textile fibre materials that are undyed, fluorescent whitened or dyed with reactive, acid, metal complex or disperse dyes, wherein the fibre material is treated with a liquor comprising a composition according to claim 1.
